(19) United States
(12) Patent Application Publication
(10) Pub. No.: US 2025/0357634 A1
(43) Pub. Date: Nov. 20, 2025

(54) SEPARATOR FOR LITHIUM SECONDARY BATTERY AND LITHIUM SECONDARY BATTERY COMPRISING SAME

(71) Applicants: SAMSUNG SDI CO., LTD., Yongin-si (KR); SAMSUNG ELECTRONICS CO., LTD., Suwon-si (KR)

(72) Inventors: Minho CHO, Yongin-si (KR); Rae Sung KIM, Yongin-si (KR); Hana KIM, Yongin-si (KR); Myungkook PARK, Yongin-si (KR); Seung Rim YANG, Yongin-si (KR); Byungmin LEE, Yongin-si (KR); Jungsue JANG, Yongin-si (KR); Bokyung JUNG, Yongin-si (KR)

(21) Appl. No.: 19/290,659

(22) Filed: Aug. 5, 2025

Related U.S. Application Data
(63) Continuation of application No. 17/435,086, filed on Aug. 31, 2021.

(30) Foreign Application Priority Data
Mar. 7, 2019 (KR) 10-2019-0026495

(51) Int. Cl. H01M 50/457; H01M 10/0525; H01M 50/409; H01M 50/426; H01M 50/431; H01M 50/434; H01M 50/443; H01M 50/446; H01M 50/489; H01M 50/491

(52) U.S. Cl. CPC H01M 50/457; H01M 50/409; H01M 50/426; H01M 50/431; H01M 50/434; H01M 50/443; H01M 50/446; H01M 50/489; H01M 50/491; H01M 10/0525

(57) ABSTRACT

The present disclosure relates to a separator for a lithium secondary battery, and a lithium secondary battery including same, the separator including: a porous substrate, and a heat-resistant layer on at least one surface of the porous substrate, wherein the heat-resistant layer includes a first coating layer including alumina, and a second coating layer including magnesium hydroxide, and the first coating layer and the second coating layer are consecutively disposed in a stacked form on the porous substrate.

### CROSS REFERENCE TO RELATED APPLICATIONS

This is a continuation application based on pending application Ser. No. 17/435,086, filed Aug. 31, 2021, the entire contents of which are hereby incorporated by reference.

Application Ser. No. 17/435,086 is the U.S. national phase application based on PCT Application No. PCT/KR2019/009312, filed Jul. 26, 2019, which is based on Korean Patent Application No. 10-2019-0026495, filed Mar. 7, 2019, the entire contents of all being hereby incorporated by reference.

### TECHNICAL FIELD

A separator for lithium secondary battery and a lithium secondary battery including the same are disclosed.

### BACKGROUND ART

A separator for an electrochemical battery is an intermediate film that separates a positive electrode and a negative electrode in a battery, and maintains ion conductivity continuously to enable charge and discharge of a battery. When a battery is exposed to a high temperature environment due to abnormal behavior, a separator may be mechanically shrinks or is damaged due to melting characteristics at a low temperature. Herein, the positive and negative electrodes contact each other and may cause an explosion of the battery. In order to overcome this problem, technology of suppressing shrinkage of a separator and ensuring stability of a battery is required.

### DISCLOSURE

### Technical Problem

The present invention provides a separator for a lithium secondary battery capable of simultaneously improving penetration safety and thermal stability, and a lithium secondary battery including the same.

### Technical Solution

In an embodiment, a separator for lithium secondary battery includes a porous substrate, and a heat-resistant layer on at least one surface of the porous substrate, wherein the heat-resistant layer includes at least one first coating layer including alumina and at least one second coating layer containing magnesium hydroxide, and the first coating layer and the second coating layer are continuously and alternately disposed on the porous substrate in a stacked form.

Another embodiment provides a lithium secondary battery including a positive electrode, a negative electrode, and a separator for the lithium secondary battery between the positive electrode and the negative electrode.

### Advantageous Effects

The present invention provides a lithium secondary battery in which safety is secured when an event occurs by including a separator for a lithium secondary battery that can improve penetration safety and thermal safety at the same time.

### DESCRIPTION OF THE DRAWINGS

FIG. 1 is a schematic view of a separator for a lithium secondary battery according to an embodiment.

FIG. 2 is a schematic view of a separator for a lithium secondary battery according to another embodiment.

FIG. 3 is a schematic view of a separator for a lithium secondary battery according to another embodiment.

FIG. 4 schematically shows the structure of a lithium secondary battery according to an embodiment.

<Description of Symbols>

| | |
|---|---|
| 110: porous substrate | 100, 200: heat-resistant layer |
| 120, 120′: first coating layer | 130, 130′: second coating layer |
| 1: lithium secondary battery | 11: positive electrode |
| 12: negative electrode | 13: separator |
| 10: electrode assembly | 20: case |
| 21: uppercase | 22: lower case |
| 40: positive terminal | 50: negative terminal |
| 60: insulation member | 221: inner space of the lower case |
| 222: sealing portion | |

### MODE FOR INVENTION

Hereinafter, embodiments of the present invention are described in detail. However, these embodiments are exemplary, the present invention is not limited thereto and the present invention is defined by the scope of claims.

Hereinafter, “combination thereof” refers to a mixture, a copolymer, a blend, an alloy, a composite, or a reaction product.

In the present specification, “(meth)acryl” refers to both acryl and methacryl.

In addition, the embodiments of the present invention will be described in detail, referring to the accompanying drawings. However, in the description of the present disclosure, descriptions for already known functions or components will be omitted for clarifying the gist of the present disclosure.

In order to clearly describe the present disclosure, parts which are not related to the description are omitted, and the same reference numeral refers to the same or like components, throughout the specification. In addition, since the size and the thickness of each component shown in the drawing are optionally represented for convenience of the description, the present disclosure is not limited to the illustration.

In the drawings, the thickness of layers, films, panels, regions, etc., are exaggerated for clarity. In the drawings, the thickness of a part of layers or regions, etc., is exaggerated for clarity. It will be understood that when an element such as a layer, film, region, or substrate is referred to as being “on” another element, it can be directly on the other element or intervening elements may also be present.

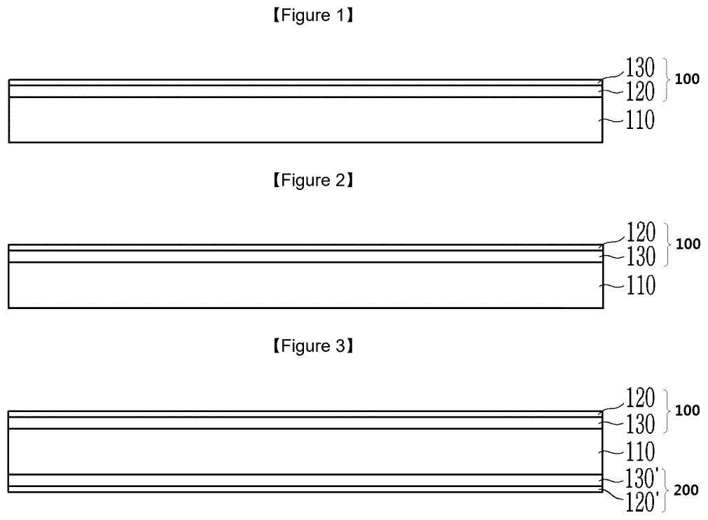

FIG. 1 is a cross-sectional view schematically illustrating a cross-section of a separator for a lithium secondary battery according to an embodiment. Hereinafter, a separator for a lithium secondary battery according to an embodiment of the present invention is described with reference to FIG. 1.

Referring to FIG. 1, the separator for a lithium secondary battery according to an embodiment includes a porous substrate 110 and a heat-resistant layer 100, and the heat-resistant layer 100 includes a first coating layer 120 including alumina and a second coating layer 130 including magnesium hydroxide, and the first coating layer 120 and the second coating layer 130 may be continuously disposed in a stacked form on the porous substrate 110.

The porous substrate 110 may have a plurality of pores and may generally be a porous substrate used in an electrochemical device. The porous substrate 110 may be a polymer film formed of any one polymer selected from polyolefin such as polyethylene and polypropylene, polyester such as polyethylene terephthalate and polybutylene terephthalate, polyacetal, polyamide, polyimide, polycarbonate, polyetheretherketone, polyaryl etherketone, polyetherimide, polyamideimide, polybenzimidazole, polyethersulfone, polyphenyleneoxide, a cyclic olefin copolymer, polyphenylenesulfide, polyethylenenaphthalate, a glass fiber, Teflon, polytetrafluoroethylene, or a copolymer or mixture of two or more of them, but is not limited thereto.

The porous substrate 110 may be for example a polyolefin-based substrate, and the polyolefin-based substrate may improve has safety of a battery due to its improved shutdown function. The polyolefin-based substrate may be for example selected from a polyethylene single film, a polypropylene single film, a polyethylene/polypropylene double film, a polypropylene/polyethylene/polypropylene triple film, and a polyethylene/polypropylene/polyethylene triple film. In addition, the polyolefin-based resin may include a non-olefin resin in addition to an olefin resin or a copolymer of olefin and a non-olefin monomer.

The porous substrate 110 may have a thickness of about 1 μm to 40 μm, for example, 1 μm to 30 μm, 1 μm to 20 μm, 5 μm to 20 μm, 5 μm to 15 μm, or 10 μm to 15 μm.

The heat-resistant layer is disposed on at least one surface of the porous substrate and includes at least one first coating layer including alumina and at least one second coating layer including magnesium hydroxide, and for example, the first coating layer and the second coating layer may be formed by coating on one surface of the porous substrate by a gravure coating method.

When the first coating layer and the second coating layer are one or more, the first coating layer and the second coating layer may be alternately stacked.

For example, as shown in FIG. 1, the porous substrate 110, the first coating layer 120 including alumina, and the second coating layer 130 including magnesium hydroxide may be stacked in this order.

For another example, as shown in FIG. 2, the porous substrate 110, the second coating layer 130 including magnesium hydroxide, and the first coating layer 120 including alumina may be stacked in this order.

For still another example, the heat-resistant layer may be coated on both surfaces of the porous substrate, the first coating layer and the second coating layer may be stacked in each order shown in FIGS. 1 and 2.

For example, as shown in FIG. 3, first coating layers 120 and 120′ are disposed on both surfaces of the porous substrate, and second coating layers 130 and 130′ may be respectively formed on the first coating layers.

The heat-resistant layer includes a coating layer simultaneously including alumina (Al₂O₃) and magnesium hydroxide (Mg(OH)₂) and thus may prevent a separator from being rapidly contracted or deformed due to a temperature increase or penetration.

In particular, when an inorganic material layer including the alumina alone is included, weak penetration stability may be obtained, and on the other hand, when an inorganic material layer including the magnesium hydroxide alone is included, weak thermal stability according to a temperature increase may be obtained, but the separator according to an embodiment may be prevented from battery ignition/explosion during exposure to a high temperature of 150° C. or higher or penetration by forming each separate layer with alumina with high stability according to a temperature increase and magnesium hydroxide with high stability against the penetration and stacking them in order and thus realize both improved high temperature and penetration stability.

An average particle diameter of the alumina may be 500 nm to 800 nm, for example, 600 nm to 800 nm and more specifically, 700 nm to 800 nm.

An average particle diameter of the magnesium hydroxide may be 600 nm to 1 μm, for example 800 nm to 1 μm, and more specifically 800 nm to 850 nm.

When the average particle diameter of the magnesium hydroxide is less than 600 nm, air permeability may be deteriorated, but when the average particle diameter of the magnesium hydroxide is greater than 1 μm, dispersibility of particles and coating uniformity of a separator may be deteriorated. Accordingly, magnesium hydroxide having an average particle diameter of 600 nm to 1 μm may be used to realize a separator having excellent air permeability, dispersibility, and coating uniformity.

The average particle diameter may be a particle size (D₅₀) at 50% of a volume ratio in a cumulative size-distribution curve.

A ratio of the average particle diameter of the magnesium hydroxide to that of the alumina may be 1 to 1.6, for example, 1 to 1.3, and more specifically, 1 to 1.1.

The heat-resistant layer 100 may have a thickness of 3.5 μm to 7 μm. For example, the thickness may be in a range of 3.5 μm to 6 μm or 3.5 μm to 5 μm.

A thickness ratio of the heat-resistant layer relative to the porous substrate may be 0.05 to 0.5, for example, 0.05 to 0.4 or 0.05 to 0.3. Herein, a separator including the porous substrate and the heat-resistant layer may exhibit excellent air permeability and heat resistance.

Each thickness of the first coating layer 120 and the second coating layer 130 may be greater than 1.5 μm and less than or equal to 3.5 μm, for example, 2 μm to 3.5 μm or 2 μm to 3 μm.

When at least one of the first coating layer and the second coating layer has a thickness of less than or equal to 1.5 μm, adherence to an electrode plate is decreased, resultantly deteriorating thermal stability and penetration stability.

In other words, when the first coating layer and the second coating layer have a thickness within the ranges, a separator with improved thermal safety and penetration stability may be realized.

The first coating layer 120 and the second coating layer 130 included in the heat-resistant layer 100 may respectively further include a water-soluble polymer binder (not shown). The water-soluble polymer binder connects inorganic particles included in the heat-resistant layer 100, that is, between alumina or between magnesium hydroxide in a point-contact or surface-contact method and thus may prevent detachment of the inorganic particles.

The alumina and the magnesium hydroxide may be included in an amount of 85 wt % to 98 wt % based on 100 wt % of a total weight of the heat-resistant layer. In other words, the alumina and the magnesium hydroxide: the water-soluble polymer binder may be included in a weight ratio of 85:15 to 98:2.

When the inorganic particles included in the coating layer, that is, the alumina and the magnesium hydroxide are used in an amount of less than 85 wt %, air permeability may be deteriorated, but when used in an amount of greater than 98 wt %, dispersion stability of dispersion may be deteriorated, and accordingly, a bonding force between the porous substrate and the coating layer may be deteriorated, resulting in detaching the coating layer. In other words, when the inorganic particles are used in an amount of 85 wt % to 98 wt %, a separator may exhibit excellent air permeability and durability as well as thermal stability.

For example, the alumina and the magnesium hydroxide may be 88 wt % to 98 wt %, for example, 90 wt % to 98 wt %, 94 wt % to 98 wt %, or 95 wt % to 98 wt % based on 100 wt % of the total weight of the heat-resistant layer.

Specifically, in an embodiment, the alumina may be 85 wt % to 98 wt % or 88 wt % to 98 wt % and more specially, for example, 90 wt % to 98 wt %, 94 wt % to 98 wt %, or 95 wt % to 98 wt % based on the total weight of the first coating layer.

In addition, the magnesium hydroxide may be 85 wt % to 98 wt % or 88 wt % to 98 wt % and more specifically, for example, 90 wt % to 98 wt %, 94 wt % to 98 wt %, or 95 wt % to 98 wt % based on the total weight of the second coating layer.

The water-soluble polymer binder according to an embodiment may include a (meth)acryl-based binder, a cellulose-based binder, a vinylidene fluoride-based binder, or a combination thereof.

The (meth)acryl-based binder may include, for example, an acryl-based copolymer including a repeating unit derived from an alkyl (meth)acrylate monomer. Examples of the alkyl (meth)acrylate monomer may include at least one selected from n-butyl (meth)acrylate, ethyl (meth)acrylate, propyl (meth)acrylate, t-butyl (meth)acrylate, isobutyl (meth)acrylate, pentyl (meth)acrylate, hexyl (meth)acrylate, heptyl (meth)acrylate, isooctyl (meth)acrylate, octyl (meth)acrylate, nonyl (meth)acrylate, decyl (meth)acrylate, undecyl (meth)acrylate, lauryl (meth)acrylate, methyl (meth)acrylate, isobornyl (meth)acrylate, cyclohexyl (meth)acrylate, but is not limited thereto. For example, a linear or branched alkyl (meth)acrylate having 1 to 20 carbon atoms, or a linear or branched alkyl (meth)acrylate having 1 to 20 carbon atoms may be used.

The (meth)acryl-based copolymer may be a copolymer including one or more functional groups selected from an OH group, a COOH group, a CN group, an amine group, and an amide group.

The (meth)acryl-based copolymer may be a copolymer including at least one first functional group and at least one second functional group. Herein, the first functional group may be selected from an OH group and a COOH group, and the second functional group may be selected from a CN group, an amine group, and an amide group.

The (meth)acryl-based copolymer may have a repeating unit derived from a monomer having a first functional group and a repeating unit derived from a monomer having a second functional group.

Non-limiting examples of the monomer having the first functional group may be more than one type selected from (meth)acrylic acid, 2-(meth)acryloyloxy acetic acid, 3-(meth)acryloyloxy propyl acid, 4-(meth)acryloyloxy butyric acid, an acrylic acid dimer, itaconic acid, maleic acid, maleic anhydride, 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 2-hydroxyethylene glycol (meth)acrylate, and 2-hydroxypropylene glycol (meth)acrylate.

The monomer having the second functional group may include one or more of a CN group, an amine group, and an amide group in its side chain, and non-limiting examples thereof may include 2-(((butoxyamino)carbonyl)oxy)ethyl (meth)acrylate, 2-(diethylamino)ethyl (meth)acrylate, 2-(dimethylamino)ethyl (meth)acrylate, 3-(diethylamino) propyl (meth)acrylate, 3-(dimethylamino) propyl (meth)acrylate, methyl 2-acetoamido (meth)acrylate, 2-(meth)acrylamidoglycolic acid, 2-(meth)acrylamido-2-methyl-1-propanesulfonic acid, (3-(meth)acrylamidopropyl)trimethyl ammonium chloride, N-(meth)acryloylamido-ethoxyethanol, 3-(meth)acryloylamino-1-propanol, N-(butoxymethyl)(meth)acryloamide, N-tert-butyl (meth)acrylamide, diacetone (meth)acrylamide, N,N-dimethyl (meth)acrylamide, N-(isobutoxymethyl) acrylamide, N-(isopropyl) (meth)acrylamide, (meth)acrylamide, N-phenyl (meth)acrylamide, N-(tris(hydroxymethyl)methyl)(meth)acrylamide, N—N′-(1,3-phenylene)dimaleimide, N—N′-(1,4-phenylene)dimaleimide, N—N′-(1,2-dihydroxyethylene)bisacrylamide, N—N′-ethylenebis(meth)acrylamide, N-vinylpyrrolidinone, (meth)acrylonitrile, alkenenitrile, cyanoalkyl(meth)acrylate, or 2-(vinyloxy)alkanenitrile. Herein, the alkene may be a C1 to C20 alkene, a C1 to C10 alkene, or a C1 to C6 alkene, the alkyl may be a C1 to C20 alkyl, a C1 to C10 alkyl, or a C1 to C6 alkyl, and the alkane may be a C1 to C20 alkane, C1 to C10 alkane, or C1 to C6 alkane.

The alkenenitrile may be, for example, allyl cyanide, 4-pentenenitrile, 3-pentenenitrile, 2-pentenenitrile, or 5-hexenenitrile. The cyanoalkyl (meth)acrylate may be, for example, cyanomethyl (meth)acrylate, cyanoethyl (meth)acrylate, cyanopropyl (meth)acrylate, or cyanooctyl (meth)acrylate. The 2-(vinyloxy)alkanenitrile may be, for example, 2-(vinyloxy) ethanenitrile or 2-(vinyloxy) propanenitrile.

Examples of the acryl-based copolymer may include any one or more selected from a (meth)acryl-based copolymer, a (meth)acryl-styrene copolymer, a (meth)acryl-acrylonitrile copolymer, a (meth)acryl-styrene-based copolymer, a (meth)acryl-acrylonitrile copolymer, a (meth)acrylic acid-acrylonitrile-acrylamide copolymer, a silicone-(meth)acryl-based copolymer, an epoxy-(meth)acryl-based copolymer, polybutadiene, polyisoprene, a butadiene-styrene random copolymer, an isoprene-syrene random copolymer, a (meth)acrylonitrile-butadiene copolymer, a (meth)acrylonitrile-butadiene-styrene copolymer, an ethylene-vinyl acetate copolymer, a (meth)acryl-urethane copolymer, and a vinyl acetate-based copolymer.

The cellulose-based binder may include, for example, carboxymethyl cellulose, hydroxypropyl cellulose, diacetyl cellulose, cellulose acetate, cellulose acetate butyrate, cellulose acetate propionate, cyanoethyl cellulose, cyanoethyl sucrose, pullulan, carboxymethyl cellulose, or a salt thereof.

The vinylidene fluoride-based binder may include, for example, a homopolymer including a structural unit alone derived from a vinylidene fluoride monomer, or a copolymer of a structural unit derived from vinylidene fluoride and a structural unit derived from another monomer. The copolymer may be, for example, a structural unit derived from vinylidene fluoride and one or more of structural units derived from chlorotrifluoroethylene, trifluoroethylene, hexafluoropropylene, ethylene tetrafluoride, and ethylene monomes, but is not limited thereto. For example, the copolymer may be a polyvinylidene fluoride-hexafluoropropylene (PVdF-HFP) copolymer including a structural unit derived from a vinylidene fluoride monomer and a structural unit derived from a hexafluoropropylene monomer.

In this case, the heat-resistant layer 100 may further include a polyvinyl alcohol-based auxiliary binder (not shown). The polyvinyl alcohol-based auxiliary binder may include polyvinyl alcohol, modified polyvinyl alcohol, or a combination thereof. Herein, the modified polyvinyl alcohol may be polyvinyl alcohol modified with a functional group such as a carboxyl group, a sulfonic acid group, an amino group, a silanol group, and a thiol group.

When the heat-resistant layer 100 further includes the polyvinyl alcohol-based auxiliary binder, wettability of the coating layer composition for a heat-resistant layer with the porous substrate may be improved, and accordingly, coating uniformity of the heat-resistant layer 100 may be secured.

The polyvinyl alcohol-based auxiliary binder may be included in an amount of 0.25 wt % to 3.0 wt % based on the total weight of the heat-resistant layer 100.

When the polyvinyl alcohol-based auxiliary binder is included within the range, a bonding force between the substrate and the heat-resistant layer of the separator for lithium secondary battery according to an embodiment may much improved, resultantly, much improving durability and heat resistance.

More specifically, the polyvinyl alcohol-based auxiliary binder may be included in an amount of 0.27 wt % to 2.8 wt %, for example 0.3 wt % to 2.0 wt % based on the total weight of the heat-resistant layer 100.

On the other hand, the composition for forming a coating layer may further include an initiator and a solvent in addition to the alumina, the magnesium hydroxide, the water-soluble polymer binder, and the polyvinyl alcohol-based auxiliary binder.

The initiator may be, for example, a photoinitiator, a thermal initiator, or a combination thereof. The photo initiator may be used when curing by photopolymerization using ultraviolet rays or the like.

Examples of the photoinitiator may include acetophenones such as diethoxyacetophenone, 2-hydroxy-2-methyl-1-phenylpropan-1-one, benzyldimethylketal, 1-hydroxycyclohexyl-phenylketone, 2-methyl-2-morphine (4-thiomethylphenyl) propan-1-one, and the like; benzoinethers such as benzoinmethylether, benzoinethylether, benzoinisopropylether, benzoinisobutylether, and the like; benzophenones such as benzophenone, o-benzoylbenzoic acidmethyl, 4-phenylbenzophenone, 4-benzoyl-4′-methyldiphenylsulfurous acid, 4-benzoyl-N,N-dimethyl-N-[2-(1-oxo-2-prophenyloxy)ethyl] benzenemetanamium bromide, (4-benzoylbenzyl)trimethylammonium chloride, and the like; thioxanthones such as 2,4-diethylthioxanthone, 1-chloro-4-dichlorothioxanthone, and the like; 2,4,6-trimethylbenzoyldiphenylbenzoyloxide, and the like. These may be used alone or as a mixture of two or more.

The thermal initiator may be used when curing by thermal polymerization. Examples of the thermal initiator may include an organic peroxide glass radical initiator such as diacylperoxides, peroxyketals, ketone peroxides, hydroperoxides, dialkylperoxides, peroxyesters, peroxydicarbonates, and the like, and may include, for example, lauroyl peroxide, benzoyl peroxide, cyclohexanone peroxide, 1,1-bis(t-butylperoxy)-3,3,5-trimethylcyclohexane, t-butylhydroperoxide, and the like. These may be used alone or as a mixture of two or more.

The solvent is not particularly limited, as long as it may dissolve or disperse the alumina, the magnesium hydroxide, the water-soluble polymer binder, the polyvinyl alcohol-based auxiliary binder, and the initiator and, for example, may include water (pure water, ultrapure water, distilled water, ion exchange water, and the like); alcohols such as methanol, ethanol, and isopropylalcohol; dimethyl formamide, dimethyl acetamide, tetramethylurea, triethylphosphate, N-methyl-2-pyrrolidone, dimethyl sulfoxide, acetone, methylethylketone, methylisobutylketone, cyclohexanone, or a combination thereof but is not limited thereto.

The curing may be performed through photocuring, thermal curing, or a combination thereof. The photocuring may be for example performed by radiating ultraviolet rays of 150 nm to 170 nm for 5 seconds to 60 seconds.

In addition, the thermal curing may be for example performed at 60° C. to 120° C. for 1 hour to 36 hours, for example, 80° C. to 100° C. for 10 hours to 24 hours.

The separator for a lithium secondary battery according to an embodiment may exhibit excellent air permeability, for example, less than 1000 sec/100 cc, for example, less than 300 sec/100 cc, for example, less than or equal to 250 sec/100 cc, or less than or equal to 230 sec/100 cc. Herein, the air permeability refers to time (seconds) that it takes for 100 cc of air to permeate a unit thickness of the separator. The air permeability per unit thickness may be obtained by measuring air permeability for a total thickness of the separator and dividing it with the thickness.

The separator for a lithium secondary battery according to an embodiment may be manufactured in various known methods. For example, the separator for a lithium secondary battery may be formed by coating the composition for a coating layer on one surface or both surfaces of the porous substrate and drying it.

The coating may be, for example a spin coating, a dip coating, a bar coating, a die coating, a slit coating, a roll coating, an inkjet printing, and the like, but is not limited thereto.

The drying may be for example performed through natural drying, drying with warm air, hot air, or low humid air, vacuum-drying, or irradiation of a far-infrared ray, an electron beam, and the like, but the present disclosure is not limited thereto. The drying may be for example performed at a temperature of 25° C. to 120° C.

The separator for a lithium secondary battery may be manufactured by lamination, coextrusion, and the like in addition to the above method.

Hereinafter, a lithium secondary battery including the aforementioned separator for a lithium secondary battery is described.

The lithium secondary battery may be classified as a lithium ion battery, a lithium ion polymer battery, and a lithium polymer battery according to the presence of a separator and the type of an electrolyte solution used therein. The lithium secondary battery may have a variety of shapes and sizes and thus, may include a cylindrical, prismatic, coin-type, or pouch-type battery and a thin film type or a bulky type in size. Structures and manufacturing methods for lithium ion batteries pertaining to this disclosure are well known in the art.

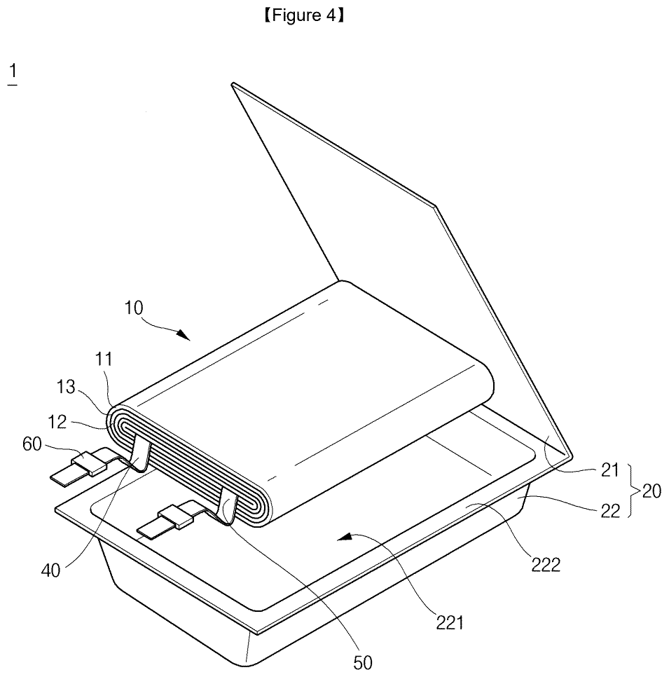

Herein, a pouch-type lithium secondary battery as one example of a lithium secondary battery is exemplarily illustrated. A lithium secondary battery according to an embodiment is schematically shown in FIG. 4. Referring to FIG. 4, the lithium secondary battery 1 according to an embodiment of the present disclosure includes a case 20, an electrode assembly 10 inserted in the case 20, and a positive terminal 40 and a negative terminal 50 electrically connected to the electrode assembly.

As illustrated in FIG. 4, the electrode assembly 10 may be formed into a flat structure by spirally winding the separator 13 disposed between the band-shaped positive electrode 11 and negative electrode 12. Alternatively, although not illustrated, a plurality of positive and negative electrodes formed in a shape of a square sheet may be alternately stacked.

The case 20 consists of a lower case 22 and an upper case 21, and the electrode assembly 10 is housed in an inner space 221 of the lower case 22.

After housing the electrode assembly 10 in the case 20, the upper case 21 and the lower case 22 are sealed by applying a sealant to a sealing portion 222 on the edge of the lower case 22. Herein, an insulation member 60 may be wrapped where the positive terminal 40 and the negative terminal 50 contact with the case 20 to improve durability of the lithium secondary battery 1.

In addition, the positive electrode 11, the negative electrode 12, and the separator 13 may be impregnated in the electrolyte solution.

The positive electrode 11 may include a positive current collector and a positive active material layer formed on the positive current collector. The positive active material layer includes a positive active material, a positive electrode binder, and optionally a conductive material.

The positive current collector may use aluminum, nickel, and the like, but is not limited thereto.

The positive active material may use a compound capable of intercalating and deintercalating lithium. Specifically, at least one of a composite oxide or a composite phosphate of a metal selected from cobalt, manganese, nickel, aluminum, iron, or a combination thereof and lithium may be used. For example, the positive active material may be a lithium cobalt oxide, a lithium nickel oxide, a lithium manganese oxide, a lithium nickel cobalt manganese oxide, a lithium nickel cobalt aluminum oxide, a lithium iron phosphate, or a combination thereof.

The positive electrode binder improves binding properties of positive active material particles with one another and with a current collector, and specific examples may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. These may be used alone or as a mixture of two or more.

The conductive material improves conductivity of an electrode. Examples thereof may be natural graphite, artificial graphite, carbon black, a carbon fiber, a metal powder, a metal fiber, and the like, but are not limited thereto. These may be used alone or as a mixture of two or more. The metal powder and the metal fiber may use a metal of copper, nickel, aluminum, silver, and the like.

The negative electrode 12 may include a negative current collector and a negative active material layer formed on the negative current collector.

The negative current collector may use copper, gold, nickel, a copper alloy, and the like, but is not limited thereto.

The negative active material layer may include a negative active material, a binder, and optionally a conductive material. The negative active material may be a material that reversibly intercalates/deintercalates lithium ions, a lithium metal, a lithium metal alloy, a material being capable of doping and dedoping lithium, a transition metal oxide, or a combination thereof.

The material that reversibly intercalates/deintercalates lithium ions may be a carbon material which is any generally-used carbon-based negative active material, and examples thereof may be crystalline carbon, amorphous carbon, or a combination thereof. Examples of the crystalline carbon may be graphite such as amorphous, sheet-shape, flake, spherical shape or fiber-shaped natural graphite or artificial graphite. Examples of the amorphous carbon may be soft carbon or hard carbon, a mesophase pitch carbonized product, fired coke, and the like. The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn. The material capable of doping and dedoping lithium may be Si, SiOₓ (0<x<2), a Si—C composite, a Si—Y alloy, Sn, SnO₂, a Sn—C composite, a Sn—Y alloy, and the like, and at least one of these may be mixed with SiO₂. Specific examples of the element Y may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof. The transition metal oxide may be vanadium oxide, lithium vanadium oxide, and the like.

The negative electrode binder and the conductive material used in the negative electrode 12 may be the same as the positive electrode binder and conductive material of the aforementioned positive electrode 11.

The positive electrode 11 and the negative electrode 12 may be manufactured by mixing each active material composition including each active material and a binder, and optionally a conductive material in a solvent, and coating the active material composition on each current collector. Herein, the solvent may be N-methylpyrrolidone, and the like, but is not limited thereto. The electrode manufacturing method is well known, and thus is not described in detail in the present specification.

The electrolyte solution includes an organic solvent a lithium salt.

The organic solvent serves as a medium for transmitting ions taking part in the electrochemical reaction of a battery. The organic solvent may be a carbonate-based solvent, an ester-based solvent, an ether-based solvent, a ketone-based solvent, an alcohol-based solvent, and an aprotic solvent. The carbonate-based solvent may be dimethyl carbonate, diethyl carbonate, dipropyl carbonate, methylpropyl carbonate, ethylpropyl carbonate, methylethyl carbonate, ethylene carbonate, propylene carbonate, butylene carbonate, and the like, and the ester-based solvent may be methyl acetate, ethyl acetate, n-propyl acetate, 1,1-dimethylethyl acetate, methylpropionate, ethylpropionate, γ-butyrolactone, decanolide, valerolactone, mevalonolactone, caprolactone, and the like. The ether-based solvent may be dibutyl ether, tetraglyme, diglyme, dimethoxyethane, 2-methyltetrahydrofuran, tetrahydrofuran, and the like, and the ketone-based solvent may be cyclohexanone, and the like. The alcohol-based solvent may be ethanol, isopropyl alcohol, and the like, and the aprotic solvent may be nitriles such as R—CN (R is a C2 to C20 linear, branched, or cyclic hydrocarbon group, a double bond, an aromatic ring, or an ether bond), and the like, amides such as dimethyl formamide, dioxolanes such as 1,3-dioxolane, sulfolanes, and the like.

The organic solvent may be used alone or in a mixture of two or more, and when the organic solvent is used in a mixture of two or more, the mixture ratio may be controlled in accordance with a desirable cell performance.

The lithium salt is dissolved in an organic solvent, supplies lithium ions in a battery, basically operates the lithium secondary battery, and improves lithium ion transportation between positive and negative electrodes therein. Examples of the lithium salt may include LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂) (C_{y}F_{2y+1}SO₂) (x and y are natural numbers), LiCl, LiI, LiB (C₂O₄)₂, or a combination thereof, but are not limited thereto.

The lithium salt may be used in a concentration ranging from 0.1 M to 2.0 M. When the lithium salt is included within the above concentration range, an electrolyte solution may have excellent performance and lithium ion mobility due to optimal conductivity and viscosity of the electrolyte solution.

### DETAILED DESCRIPTION OF THE EMBODIMENTS

Hereinafter, the above aspects of the present disclosure are illustrated in more detail with reference to examples. However, these examples are exemplary, and the present disclosure is not limited thereto.

### EXAMPLES

### Example 1

55 wt % of alumina (AES11, Sumitomo Chemical Co., Ltd.), 1.1 wt % of a (meth)acryl-based copolymer (HCM-100S, Hansol Chemical), and 43.9 wt % of DI water were mixed with a bead mill, preparing alumina dispersion with D50 of 0.8 μm. 70.71 wt % of the alumina dispersion, 0.33 wt % of PVA (Daejung Chemicals & Metals Co., Ltd.), and 28.96 wt % of DI water were mixed with a mechanical stirring equipment, preparing a first coating layer composition having a solid content of 40 wt %. The first coating layer composition was coated to be 2 μm thick on one surface of a polyethylene porous substrate (14 μm, Toray Industries Inc.) in a gravure coating method and then, dried at 70° C. for 10 minutes to form a first coating layer.

50 wt % of magnesium hydroxide (Kisuma5, Kisuma Chemicals), 1.0 wt % of a (meth)acryl-based copolymer (HCM-100S, Hansol Chemical), and 49 wt % of DI water were mixed with a bead mill, preparing magnesium hydroxide dispersion with D50 of 0.8 μm. 87.5 wt % of the magnesium hydroxide dispersion, 0.375 wt % of PVA (Daejung Chemicals & Metals Co., Ltd.), and 12.125 wt % of DI water were mixed with a mechanical stirring equipment, preparing a second coating layer composition having a solid content of 45 wt %. The second coating layer composition was coated to be 2 μm thick in a gravure coating method on one upper surface of the first coating layer and dried at 70° C. for 10 minutes to form a second coating layer, obtaining a separator having a double-layered inorganic material layer for a secondary battery.

### Example 2

A separator for a secondary battery was manufactured according to the same method as Example 1 except that the second coating layer of Example 1 was first formed on one single surface of a polyethylene porous substrate (14 μm, Toray Industries Inc.), and subsequently, the first coating layer of Example 1 was formed on one upper surface of the second coating layer.

### Comparative Example 1

A separator for a secondary battery was manufactured according to the same method as Example 1 except that the first coating layer was formed to be 4 μm thick without forming the second coating layer.

### Comparative Example 2

A separator for a secondary battery was manufactured according to the same method as Example 1 except that the second coating layer was formed to be 4 μm thick on a porous substrate without forming the first coating layer.

### Comparative Example 3

55 wt % of alumina (AES11, Sumitomo Chemical Co., Ltd.), 1.1 wt % of a (meth)acryl-based copolymer (HCM-100S, Hansol Chemical), and 43.9 wt % of DI water were mixed with a bead mill, preparing alumina dispersion with D50 of 0.8 μm. 50 wt % of magnesium hydroxide (Kisuma5, Kisuma Chemicals), 1 wt % of a (meth)acryl-based copolymer (HCM-100S, Hansol Chemical), and 49 wt % of DI water were mixed with a bead mill, preparing magnesium hydroxide dispersion with D50 of 0.8 μm. 30.9 wt % of the alumina dispersion, 56.0 wt % of the magnesium hydroxide dispersion, 0.35 wt % of PVA (Daejung Chemicals & Metals Co., Ltd.), and 12.75 wt % of DI were mixed with a mechanical stirring equipment, preparing a coating layer composition having a solid content of 45 wt %.

The coating layer composition was coated to be 4 μm thick in a gravure coating method on one single surface of a polyethylene porous substrate (14 μm, Toray Industries Inc.) and then, dried at 70° C. for 10 minutes, manufacturing a separator for a secondary battery.

### Evaluation Examples

The separators according to Examples 1 to 2 and Comparative Examples 1 to 3 were respectively used to manufacture a pouch cell of 1.5 Ah of capacity, and then, the cells were evaluated with respect to thermal exposure stability and penetration stability in the following methods, and the results are shown in Table 1.

### (Thermal Exposure Stability Evaluation Method)

The 1.5 Ah cells of 4.3 V were placed in a chamber and then, evaluated with respect to stability by increasing a chamber temperature up to 170° C. at 3° C./min.

### (Penetration Stability Evaluation Method)

The 1.5 Ah cells of 4.3 V were placed in the chamber and penetrated by a nail of 2.5 pi at a rate of 80 cm/min to evaluate stability

### (Evaluation Reference)

L0: No reaction
L1: Reversible damage to battery performance
L2: Irreversible damage to battery performance
L3: Less than 50% decrease in a weight of an electrolyte solution of a battery cell
L4: 50% or more decrease in a weight of an electrolyte solution of a battery cell
L5: Ignition or sparks (neither rupture nor explosion)
L6: Battery cell rupture (no explosion)
L7: Battery cell explosion

TABLE 1

| | Thermal exposure | Penetration stability |
|---|---|---|
| | stability evaluation | evaluation |
| Example 1 | L3 | L3 |
| Example 2 | L4 | L3 |
| Comparative Example 1 | L4 | L6 |
| Comparative Example 2 | L6 | L3 |
| Comparative Example 3 | L6 | L5 |

In summary, the separators according to the examples included a heat-resistant layer with a specific composition and structure and thus realized a secondary battery cell with excellent thermal stability and simultaneously improved penetration stability.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A separator for lithium secondary battery, the separator comprising:
a porous substrate and a heat-resistant layer on at least one surface of the porous substrate, wherein:
the heat-resistant layer includes at least one first coating layer including alumina and at least one second coating layer containing magnesium hydroxide, and
a ratio of an average particle diameter ratio of the magnesium hydroxide to an average particle diameter of the alumina is 1 to 1.6.

2. The separator of claim 1, wherein the first coating layer and the second coating layer are continuously and alternately disposed in a stacked form on the porous substrate.

3. The separator of claim 1, wherein the first coating layer is disposed on at least one surface of the porous substrate and the second coating layer is disposed on the first coating layer.

4. The separator of claim 1, wherein the second coating layer is disposed on at least one surface of the porous substrate, and the first coating layer is disposed on the second coating layer.

5. The separator of claim 1, wherein:
an average particle diameter of the alumina is 500 nm to 800 nm, and
an average particle diameter of the magnesium hydroxide is 600 nm to 1 μm.

6. The separator of claim 1, wherein a thickness of each of the first coating layer and the second coating layer is greater than 1.5 μm and less than or equal to 3.5 μm.

7. The separator of claim 1, wherein each of the first coating layer and the second coating layer further comprise a water-soluble polymer binder.

8. The separator of claim 7, wherein a weight ratio of the alumina and the magnesium hydroxide: the water-soluble polymer binder is 85:15 to 98:2.

9. The separator of claim 7, wherein the water-soluble polymer binder comprises an acryl-based binder, a cellulose-based binder, a vinylidene fluoride-based binder, or a combination thereof.

10. The separator of claim 7, wherein each of the first coating layer and the second coating layer further comprises a polyvinyl alcohol-based auxiliary binder.

11. A lithium secondary battery, comprising:
a positive electrode,
a negative electrode, and
the separator for lithium secondary battery of claim 1 between the positive electrode and the negative electrode.
